(19) United States
(12) Patent Application Publication
(10) Pub. No.: US 2025/0082041 A1
(43) Pub. Date: Mar. 13, 2025

(54) AEROSOL PROVISION DEVICE

(71) Applicant: NICOVENTURES TRADING LIMITED, London (GB)

(72) Inventors: Ashley John SAYED, London (GB); Matthew TIDNAM, London (GB); Luke James WARREN, London (GB)

(21) Appl. No.: 18/957,256

(22) Filed: Nov. 22, 2024

Related U.S. Application Data
(63) Continuation of application No. 17/593,188, filed on Sep. 10, 2021, now abandoned.

(30) Foreign Application Priority Data
Mar. 11, 2019 (GB) 1903250.7

(51) Int. Cl. A24F 40/60; A24F 40/40

(52) U.S. Cl. CPC A24F 40/60; A24F 40/40

(57) ABSTRACT

An aerosol provision device is provided. The aerosol provision device includes one or more Light Emitting Diodes (LEDs) and an outer member positioned above the one or more LEDs, wherein the outer member defines a plurality of apertures visible from outside the aerosol provision device.

### PRIORITY CLAIM

The present application is a continuation application of U.S. patent application Ser. No. 17/593,188 filed Sep. 10, 2021, which is a National Phase entry of PCT Application No. PCT/EP2020/056234, filed Mar. 9, 2020, which claims priority from GB Patent Application No. 1903250.7, filed Mar. 11, 2019, each of which is hereby fully incorporated herein by reference.

### TECHNICAL FIELD

The present disclosure relates to an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided an aerosol provision device including one or more Light Emitting Diodes, LEDs, and an outer member positioned above the one or more LEDs, wherein the outer member defines a plurality of apertures visible from outside the aerosol provision device.

Further features and advantages of the present disclosure will become apparent from the following description of embodiments, given by way of example only, which is made with reference to the accompanying drawings.

### BRIEF DESCRIPTION OF THE DRAWINGS

FIG. 1 shows a front view of an example of an aerosol provision device according to an embodiment.

FIG. 2 shows a front view of the aerosol provision device of FIG. 1 with an outer cover removed.

FIG. 3 shows a cross-sectional view of the aerosol provision device of FIG. 1.

FIG. 4 shows an exploded view of the aerosol provision device of FIG. 2.

FIG. 5A shows a cross-sectional view of a heating assembly within an aerosol provision device according to an embodiment.

FIG. 5B shows a close-up view of a portion of the heating assembly of FIG. 5A.

FIG. 6 shows a front view of an embodiment of the aerosol provision device of FIG. 1.

FIG. 7 shows a perspective view of the housing of the aerosol provision device of FIG. 6.

FIG. 8 shows a perspective view of the aerosol provision device of FIG. 6 without the housing.

FIG. 9 depicts a perspective view of LEDs arranged within the aerosol provision device of FIG. 8.

FIG. 10 shows an outer member comprising a plurality of apertures according to an embodiment.

FIG. 11 shows an exploded view of components of the aerosol provision device of FIG. 8 configured to be arranged above the LEDs.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

A first aspect of the present disclosure defines an aerosol provision device comprising one or more Light Emitting Diodes (LEDs) and an outer member positioned above the one or more LEDs. The outer member comprises a plurality of apertures visible from outside the aerosol provision device. Electromagnetic radiation (in the form of visible light for example) can pass through the plurality of apertures and be viewed by a user. At least a portion of the outer member may form an outer surface of the device.

It has been found that the plurality of apertures allows light from the LEDs to be seen from a wide range of angles. In one example, the plurality of apertures are slots. A slot is an opening/aperture which is longer than it is wide. A slot can be a long narrow aperture or slit for example. A slot increases the viewing angle of the LEDs when compared to a circular or square aperture without necessarily increasing the area of the aperture. The plurality of apertures may be elongate. The plurality of apertures may be rectangular shaped (such as a rounded rectangle), elliptical, wavy or serpentine shaped.

The outer member may be a disk. For example, the outer member may have a circular, square or rectangular shape. The outer member may be substantially flat (and therefore define a plane) or may define a curved surface.

In one example the outer member comprises aluminum. Aluminum is lightweight and can be easily machined to comprise the plurality of apertures.

In some examples the aerosol provision device comprises a housing, such as an outer cover/casing. The housing may delimit an opening and the device may comprise a user input device arranged within the opening. The user input device may be configured to receive a user input for controlling the device. The outer member may be positioned within the opening, such that light from the one or more LEDs can pass through the plurality of apertures and the opening. A user may interact with the user input device to turn the device on and off, to configure settings of the device and/or to select specific heating modes.

The LEDs may be quantum dot LEDs. In some examples, the one or more LEDs can be replaced with other visible light emitting devices. More generally, the LEDs may be replaced by one or more light sources, visible light sources, semiconductor light sources, or visible light assemblies.

The outer member may have a depth/thickness, measured in a direction from the outer surface of the device towards the LEDs. The thickness may be measured in a direction perpendicular to a longitudinal axis of the device, for example. In one example, the outer member has a thickness of less than about 2 mm, such as less than about 1 mm or less than about 0.5 mm. In embodiments the outer member has a thickness of greater than about 0.2 mm and less than about 0.5 mm, such as between about 0.22 mm and about 0.3 mm. A thickness within this range provides a balance between increasing the viewing angle of the LEDs (by making the outer member thinner) and ensuring the outer member is robust (by making the outer member thicker).

It has been found that when the outer member has a thickness of around 0.3 mm (±0.03 mm) it is easier to manufacture (via chemical etching, for example). In certain examples, when the thickness is greater than 0.3 mm, it can be difficult to chemically etch the plurality of apertures.

In some examples the outer member and the plurality of apertures are made via chemical etching.

In embodiments, the thickness of the outer member is greater than about 0.22 mm. It has been found that thicknesses greater than this stop or reduce deformation of the outer member the outer member is pressed.

In embodiments, the thickness of the outer member is between about 0.22 mm and about 0.3 mm. This provides a good balance between the above considerations.

The thickness of the outer member may be the average thickness. The plurality of apertures have a depth equal to the thickness of the outer member. Light rays which are perpendicular to the outer member therefore travel through the apertures by a distance equal to the thickness of the outer member.

The plurality of apertures may have a length of less than about 2 mm. The length of an aperture is measured in a direction along an outer surface of the outer member. The length is therefore measured in a direction that is perpendicular to the thickness dimension of the outer member. As mentioned, the plurality of apertures may be slots which have a length dimension that is longer than the width dimension. The plurality of apertures can have a length of less than about 1 mm, such as between about 0.9 mm and about 1 mm. These lengths provide a wide viewing angle without compromising the structural integrity of the outer member.

The plurality of apertures may have a width of less than about 0.5 mm. The width of an aperture is measured in a direction along an outer surface of the aerosol device (or along an outer surface of the outer member). The width is therefore measured in a direction that is perpendicular to the thickness dimension of the outer member. As mentioned, the plurality of apertures may be slots which have a length dimension that is longer than the width dimension. The width direction may therefore be measured in a direction that is perpendicular to the length dimension. The plurality of apertures can have a width of less than about 0.5 mm, such as about 0.3 mm. An aperture with the above dimensions allows a wide viewing angle while keeping the area size of the aperture relatively small such that the aperture does not accumulate dirt and liquid.

In some examples, the width of the apertures is equal to or greater than the thickness of the outer member. It has been found that this ensures that the side walls of the apertures remain relatively smooth. In addition, in some examples the outer member comprises a coating of paint (such as soft touch paint). It has been found that when the width of the apertures is greater than about 0.3 mm, the paint is less likely to clog the apertures. By reducing clogging, a more consistent and brighter intensity of light is provided through the apertures.

The outer member may be positioned above the LEDs by a distance of between about 1.5 mm and about 5 mm, or between about 2 mm and about 3 mm, such as between about 2 mm and about 2.5 mm. That is, the outer surface of the outer member may be positioned away from an outer surface of the LEDs by this distance. The outer surface of an LED is the surface closest to the outer member. These distances provide a good balance between increasing the viewing angle of the light (by the LEDs being arranged closer to the outer member) and ensuring that the light from the LEDs can disperse through each of the apertures (by the LEDs being arranged further away from the outer member).

In some examples, the plurality of apertures are slots, and wherein an angle of less than about 45° is subtended between a longest dimension of the slots and a radius of the outer member. The radius and longest dimension coincide at one end of the slot. The longest dimension of a slot is its length dimension. In embodiments the angle is less than about 30°. The slots are arranged such that the longest dimension extends generally outwards from the center of the outer member, thereby increasing the viewing angle of the LEDs. The outer member may be circular, for example. In a particular example the angle is about 0°, such that the slots are aligned radially, in other words parallel to the radius of the outer member. Each of the slots may therefore radiate from a common center on the outer member.

The plurality of apertures may be arranged towards a periphery of the outer member. In other words, the apertures may be arranged closer to the outer edge of the outer member than the center of the outer member. This can allow the light from the LEDs to be seen when a user is pressing or touching the outer member. For example, the user may be interacting with a user input device. The user input device may be positioned below, or towards, the center of the outer member.

The plurality of apertures may be equally spaced around the outer perimeter of the outer member. The plurality of apertures may comprise 36 apertures. The apertures may be spaced apart by about 10°.

The device may further comprise adhesive between the one or more LEDs and the outer member. The adhesive may be an adhesive layer for example. The adhesive layer can adhere the outer member to the device and can also act to diffuse/soften the light emitted from the LEDs. This can more evenly distribute the light though the apertures, which can avoid certain apertures appearing brighter than other apertures. The adhesive may therefore be translucent.

In one example, the adhesive is an adhesive assembly comprising two or more layers of adhesive. In one example, the adhesive assembly further comprises one or more layers of plastics material, such as polyethylene terephthalate (PET). In a specific example, the adhesive assembly comprises a layer of plastics material arranged between two layers of adhesive. The adhesive is adhered to the plastics material. The layer of plastics material can alternatively or additionally diffuse/soften the light.

In a specific example the plastics layer is less than about 0.05 mm thick, such as about 0.03 mm thick, and each of the two adhesive layers are less than about 0.05 mm thick, such as less than about 0.04 mm thick. In a specific example, the adhesive layer is about 0.1 mm thick, such as about 0.105 mm thick.

An adhesive layer may be provided on each side of the plastics layer, and each adhesive layer may have different bonding properties. For example, the adhesive layer on one side may have a stronger bond or be optimized to bond with different materials than the other side. In embodiments the adhesive assembly comprises a layer of silicone adhesive on one side of a PET layer and a layer of acrylic adhesive on the other side of a PET layer. Such an adhesive assembly is commercially available as Tesa® 61532, from Tesa SE. This has been found to provide sufficient strength to prevent the outer member from becoming loose.

The device may further comprise a light-shaping member positioned between the one or more LEDs and the adhesive (or adhesive assembly). The light shaping member may comprise one or more light pipes to guide light through the light-shaping member to produce a particular pattern or design. The light-shaping member may comprise opaque regions configured to block a portion of the light from the LEDs. The light-shaping member may comprise transparent or translucent regions to allow the light to pass through. The light-shaping member may alternatively comprise openings to allow the light to pass through. A light-shaping member that comprises opaque regions and transparent or translucent regions may be more robust than a light-shaping member with openings. Translucent regions can also additionally diffuse/soften the light.

In some examples, the light shaping member is formed from two or more overmolded components. For example, the opaque and transparent/translucent regions may be formed from two overmolded components.

In one example, the light-shaping member comprises an opaque region extending around the periphery/perimeter/circumference of the light-shaping member. This can prevent light from leaking around the outside of the outer member. The opaque region may be an outer ring.

In one example the opaque region is colored black or dark grey.

In one example, the opaque region is cross-shaped.

In a specific example, the device comprises four LEDs, wherein each of the four LEDs is located below the light-shaping member and are positioned between adjacent opaque regions such that the light from the LEDs separates into 4 quadrants. The opaque regions are configured to prevent light bleed from one quadrant to the adjacent quadrant.

The light-shaping member may comprise a plastics material, for example polycarbonate. Polycarbonates are strong and can be made optically transparent/translucent. In one example, the polycarbonate is Lexan™.

The device may comprise a sealing member arranged between the light-shaping member and the plurality of LEDs. The sealing member may be a gasket, for example. The sealing member can protect against the ingress of liquid and/or dust into the device.

In another aspect, a user interface for an aerosol provision device includes one or more Light Emitting Diodes, LEDs, and an outer member positioned above the one or more LEDs, wherein the outer member defines a plurality of apertures visible from outside the aerosol provision device.

The user interface may comprise any or all of the components described above in relation to the aerosol provision device.

In embodiments, the device is a tobacco heating device, also known as a heat-not-burn device.

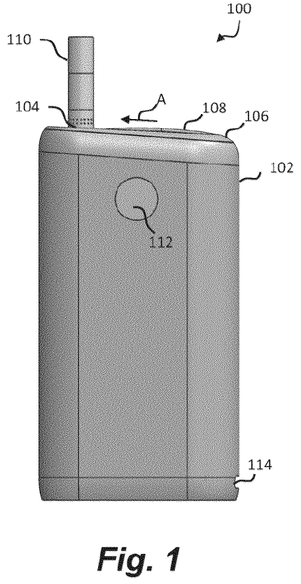

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

The device 100 comprises a housing 102 (in the form of an outer cover) which surrounds and houses various components of the device 100. The device 100 has an opening 104 in one end, through which the article 110 may be inserted for heating by a heating assembly. In use, the article 110 may be fully or partially inserted into the heating assembly where it may be heated by one or more components of the heater assembly.

The device 100 of this example comprises a first end member 106 which comprises a lid 108 which is moveable relative to the first end member 106 to close the opening 104 when no article 110 is in place. In FIG. 1, the lid 108 is shown in an open configuration, however the cap 108 may move into a closed configuration. For example, a user may cause the lid 108 to slide in the direction of arrow “A”.

The device 100 may also include a user-operable control element 112, which may comprise a button or switch, which operates the device 100 when pressed. For example, a user may turn on the device 100 by operating the control element 112.

The device 100 may also comprise an electrical connector/component, such as a socket/port 114, which can receive a cable to charge a battery of the device 100. For example, the socket 114 may be a charging port, such as a USB charging port. In some examples the socket 114 may be used additionally or alternatively to transfer data between the device 100 and another device, such as a computing device.

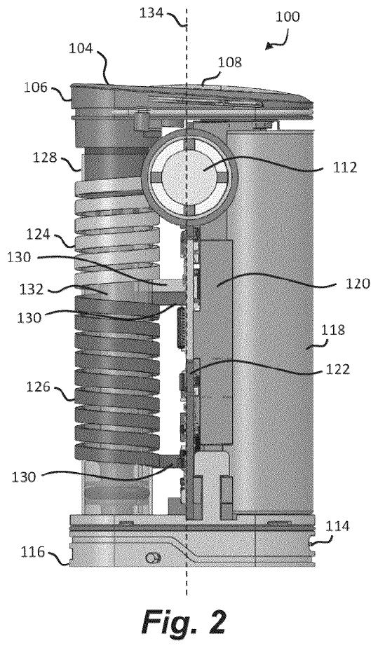

FIG. 2 depicts the device 100 of FIG. 1 with the outer cover 102 removed and without an article 110 present. The device 100 defines a longitudinal axis 134.

As shown in FIG. 2, the first end member 106 is arranged at one end of the device 100 and a second end member 116 is arranged at an opposite end of the device 100. The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. In this example, the lid 108 also defines a portion of a top surface of the device 100.

The end of the device closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows away from the distal end of the device 100.

The device 100 further comprises a power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the heating assembly to supply electrical power when required and under control of a controller (not shown) to heat the aerosol generating material. In this example, the battery is connected to a central support 120 which holds the battery 118 in place. The central support 120 may also be known as a battery support, or battery carrier.

The device further comprises at least one electronics module 122. The electronics module 122 may comprise, for example, a printed circuit board (PCB). The PCB 122 may support at least one controller, such as a processor, and memory. The PCB 122 may also comprise one or more electrical tracks to electrically connect together various electronic components of the device 100. For example, the battery terminals may be electrically connected to the PCB 122 so that power can be distributed throughout the device 100. The socket 114 may also be electrically coupled to the battery via the electrical tracks.

In the example device 100, the heating assembly is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The induction heating assembly of the example device 100 comprises a susceptor arrangement 132 (herein referred to as “a susceptor”), a first inductor coil 124 and a second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a rectangular cross section. In other examples the Litz wire can have other shape cross sections, such as circular.

The first inductor coil 124 is configured to generate a first varying magnetic field for heating a first section of the susceptor 132 and the second inductor coil 126 is configured to generate a second varying magnetic field for heating a second section of the susceptor 132. In this example, the first inductor coil 124 is adjacent to the second inductor coil 126 in a direction along the longitudinal axis 134 of the device 100 (that is, the first and second inductor coils 124, 126 do not overlap). The susceptor arrangement 132 may comprise a single susceptor, or two or more separate susceptors. Ends 130 of the first and second inductor coils 124, 126 can be connected to the PCB 122.

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIG. 2, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in opposite directions. This can be useful when the inductor coils are active at different times. For example, initially, the first inductor coil 124 may be operating to heat a first section of the article 110, and at a later time, the second inductor coil 126 may be operating to heat a second section of the article 110. Winding the coils in opposite directions helps reduce the current induced in the inactive coil when used in conjunction with a particular type of control circuit. In FIG. 2, the first inductor coil 124 is a right-hand helix and the second inductor coil 126 is a left-hand helix. However, in another embodiment, the inductor coils 124, 126 may be wound in the same direction, or the first inductor coil 124 may be a left-hand helix and the second inductor coil 126 may be a right-hand helix.

The susceptor 132 of this example is hollow and therefore defines a receptacle within which aerosol generating material is received. For example, the article 110 can be inserted into the susceptor 132. In this example the susceptor 120 is tubular, with a circular cross section.

The device 100 of FIG. 2 further comprises an insulating member 128 which may be generally tubular and at least partially surround the susceptor 132. The insulating member 128 may be constructed from any insulating material, such as plastic for example. In this particular example, the insulating member is constructed from polyether ether ketone (PEEK). The insulating member 128 may help insulate the various components of the device 100 from the heat generated in the susceptor 132.

The insulating member 128 can also fully or partially support the first and second inductor coils 124, 126. For example, as shown in FIG. 2, the first and second inductor coils 124, 126 are positioned around the insulating member 128 and are in contact with a radially outward surface of the insulating member 128. In some examples the insulating member 128 does not abut the first and second inductor coils 124, 126. For example, a small gap may be present between the outer surface of the insulating member 128 and the inner surface of the first and second inductor coils 124, 126.

In a specific example, the susceptor 132, the insulating member 128, and the first and second inductor coils 124, 126 are coaxial around a central longitudinal axis of the susceptor 132.

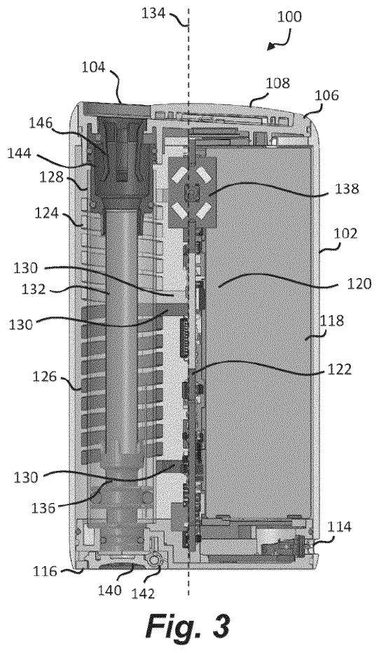

FIG. 3 shows a side view of device 100 in partial cross-section. The outer cover 102 is present in this example. The rectangular cross-sectional shape of the first and second inductor coils 124, 126 is more clearly visible.

The device 100 further comprises a support 136 which engages one end of the susceptor 132 to hold the susceptor 132 in place. The support 136 is connected to the second end member 116.

The device may also comprise a second printed circuit board 138 associated within the control element 112.

The device 100 further comprises a second lid/cap 140 and a spring 142, arranged towards the distal end of the device 100. The spring 142 allows the second lid 140 to be opened, to provide access to the susceptor 132. A user may open the second lid 140 to clean the susceptor 132 and/or the support 136.

The device 100 further comprises an expansion chamber 144 which extends away from a proximal end of the susceptor 132 towards the opening 104 of the device. Located at least partially within the expansion chamber 144 is a retention clip 146 to abut and hold the article 110 when received within the device 100. The expansion chamber 144 is connected to the end member 106.

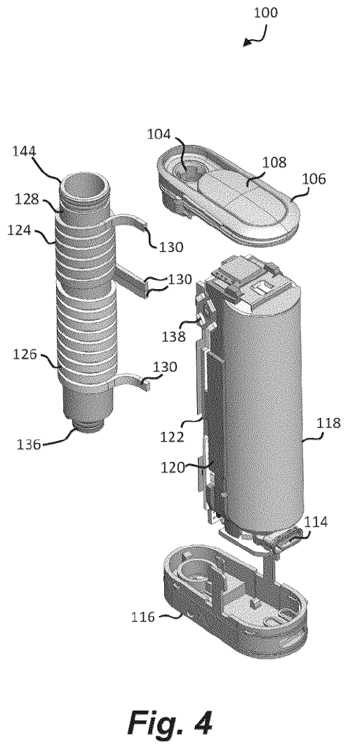

FIG. 4 is an exploded view of the device 100 of FIG. 1, with the outer cover 102 omitted.

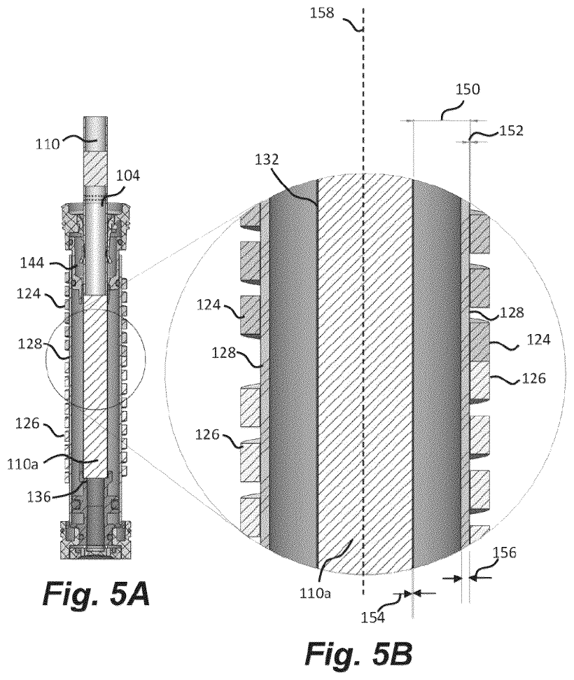

FIG. 5A depicts a cross section of a portion of the device 100 of FIG. 1. FIG. 5B depicts a close-up of a region of FIG. 5A. FIGS. 5A and 5B show the article 110 received within the susceptor 132, where the article 110 is dimensioned so that the outer surface of the article 110 abuts the inner surface of the susceptor 132. This ensures that the heating is most efficient. The article 110 of this example comprises aerosol generating material 110a. The aerosol generating material 110a is positioned within the susceptor 132. The article 110 may also comprise other components such as a filter, wrapping materials and/or a cooling structure.

FIG. 5B shows that the outer surface of the susceptor 132 is spaced apart from the inner surface of the inductor coils 124, 126 by a distance 150, measured in a direction perpendicular to a longitudinal axis 158 of the susceptor 132. In one particular example, the distance 150 is about 3 mm to 4 mm, about 3 mm to 3.5 mm, or about 3.25 mm.

FIG. 5B further shows that the outer surface of the insulating member 128 is spaced apart from the inner surface of the inductor coils 124, 126 by a distance 152, measured in a direction perpendicular to a longitudinal axis 158 of the susceptor 132. In one particular example, the distance 152 is about 0.05 mm. In another example, the distance 152 is substantially 0 mm, such that the inductor coils 124, 126 abut and touch the insulating member 128.

In one example, the susceptor 132 has a wall thickness 154 of about 0.025 mm to 1 mm, or about 0.05 mm.

In one example, the susceptor 132 has a length of about 40 mm to 60 mm, about 40 mm to 45 mm, or about 44.5 mm.

In one example, the insulating member 128 has a wall thickness 156 of about 0.25 mm to 2 mm, about 0.25 mm to 1 mm, or about 0.5 mm.

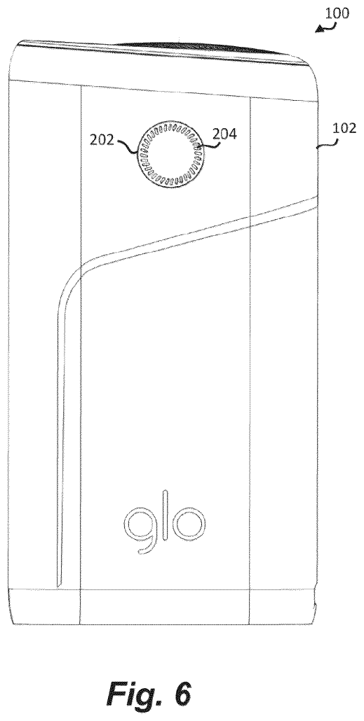

FIG. 6 depicts a front view of the device 100. As briefly mentioned above, the device may comprise a control element. In some examples the user may interact with the control element to operate the device 100. In other examples, the control element acts as a means to indicate the occurrence of one or more events to a user.

The control element may comprise a plurality of components, such as one or more light emitting diodes (LEDs) and an outer member 202 positioned above (i.e. in front of) the one or more LEDs. The outer member 202 is the outermost component of the control element. A user may press the outer member 202 to interact with the device 100. As will be described in more detail below, the outer member 202 comprises a plurality of apertures 204 through which light from the LEDs can pass. In this example the outer member 202 is circular, but in other examples it may have a different shape.

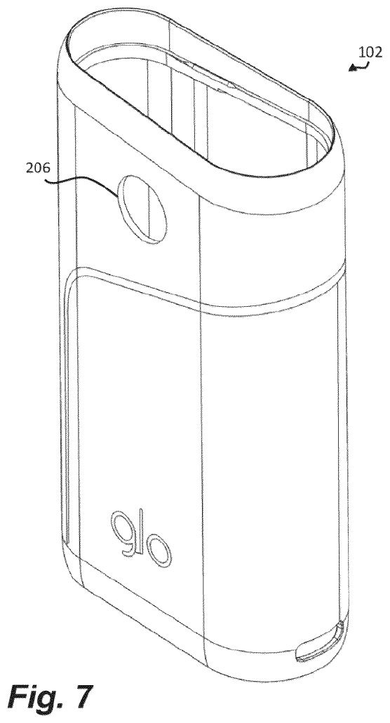

FIG. 7 depicts the housing 102 (also known as the outer cover) of the device 100. The housing 102 delimits an opening 206. The outer member (not shown in FIG. 7) can be arranged within the opening 206. For example, the outer member may be arranged flush with the outer surface of the housing 102, or may be raised above or below the outer surface of the housing 102.

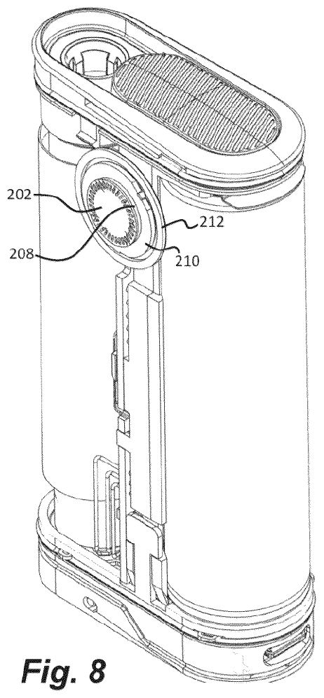

FIG. 8 depicts the device 100 without the housing 102 in place. In this example, the outer member 202 is adhered to a light-shaping member 210 via an adhesive layer 208. The adhesive in the adhesive layer 208 may partially or fully cover an inner surface of the outer member 202. Extending around the light-shaping member 210 is a sealing member 212. The light-shaping member 210 and sealing member 212 are described in more detail below.

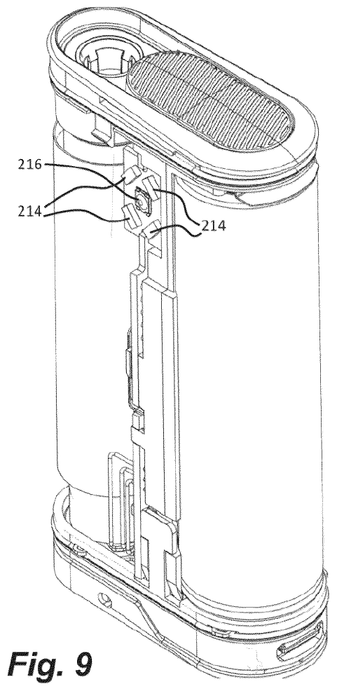

FIG. 9 depicts the device 100 with the outer member 202, light-shaping member 210 and sealing member 212 removed. The device 100 comprises four LEDs 214, although in other examples there may be other numbers of LEDs, such as one LED or more LEDs 214. The LEDs 214 are positioned below the outer member 202 such that light travels from the LEDs 214 through the plurality of apertures 204 formed in the outer member 202. The light therefore also passes through the light-shaping member 210 and the adhesive layer 208. There may also be one or more additional components arranged between the LEDs 214 and the outer member 202.

The LEDs 214 are configured to output electromagnetic radiation, such as visible light, to provide an indication to the user. In a specific example the LEDs 214 emit light to indicate when the device 100 is ready to use. The LEDs 214 may also emit light to indicate that the heater assembly is about to or has already finished heating. The LEDs 214 may operate in unison or may be operated independently. Light from each LED 214 may pass through all or a subset of the apertures 204 formed in the outer member 202.

In the example of FIG. 9, the LEDs 214 are arranged around a user input device 216 which is configured to receive/detect inputs from a user. For example, a user may press or otherwise interact with the outer member 202 which in turn is detected by the user input device 216. The user input device 216 may be button or switch which is operated when a force is applied by the user to the outer member 202. In another example the user input device 216 and the outer member 202 may be part of a capacitive sensor which detects when a user touches the outer member 202. In some examples the user input device 216 is omitted, such that the LEDs 214 act only to indicate certain events to a user.

In a particular example the outer member 202 is positioned above the one or more LEDs 214 by a distance of about 2.3 mm. The distance is measured in a direction that is perpendicular to a plane defined by the outer member 202.

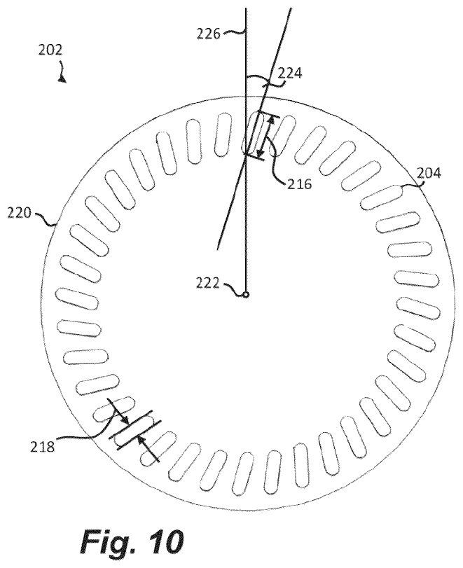

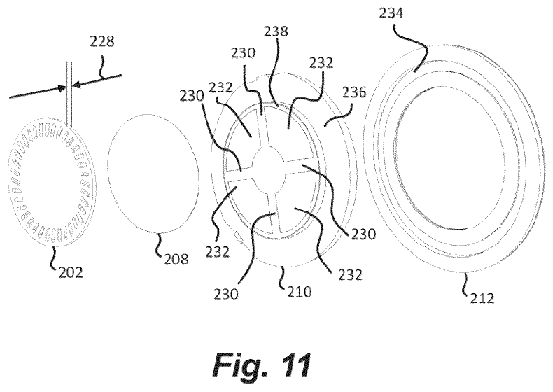

FIG. 10 depicts a front view of the outer member 202. As mentioned, the outer member 202 defines a plurality of apertures 204. In this example, the apertures 204 each form slots with a length 216 and a width 214. The lengths and widths of each aperture 204 are measured in a plane defined by the outer surface of the outer member 202. The apertures 204 also have a depth, where the depth of an aperture corresponds to the thickness 228 of the outer member 202 (shown in FIG. 11). In FIG. 10, the thickness of the outer member 202 and therefore the depth of each aperture 204 is measured in a direction perpendicular to the plane defined by the outer member 202. In FIG. 10, the thickness of the outer member 202 is measured in a direction into the page. In one example, the apertures 204 have a length 216 of about 1 mm, a width of about 0.3 mm and a depth of about 0.3 mm.

In some examples an angle 224 of less than about 45° is subtended between a longest dimension 216 of each aperture 204 and a radius 226 of the outer member 202. The longest dimension 216 of each aperture 204 corresponds to the length 216 of the aperture 204. As shown, the radius 226 and longest dimension 216 coincide at the end of the aperture 204 arranged closest to the center 222 of the outer member 202. In the example, the angle 224 is about 20°. The apertures 204 are therefore arranged such that the longest dimension 216 extends generally outwards from the center 222 of the outer member 202, thereby increasing the viewing angle of the LEDs 214.

In embodiments, the apertures 204 are arranged towards the perimeter/periphery/outer circumference 220 of the outer member 202. As shown in FIG. 10, the apertures 204 are arranged closer to the periphery 220 of the outer member 202 than the center 222 of the outer member 202. This can allow the apertures 204 to be exposed (and therefore light to be seen) even when the user is pressing the outer member 202. The user may be more likely to press/hold the center 222 of the outer member 202 rather than an edge of the outer member 202.

FIG. 11 is an exploded diagram showing some of the components of the device 100. As mentioned, the device 100 may comprise an adhesive layer 208 arranged between the LEDs 214 and the outer member 202. In the example shown, the adhesive layer is the same shape and size as the outer member 202 such that the adhesive covers the apertures 204. Light must therefore pass through the adhesive layer 208 before passing through the apertures 204. The adhesive layer 208 can therefore be transparent or translucent. A translucent adhesive layer 208 can help diffuse the light from the LEDs such that “hot spots” are avoided. A hot spot is a region where the light has a higher intensity than surrounding regions.

In some examples, the outer member 202 is attached to a light-shaping member 210 via the adhesive layer 208. In the example shown, the light shaping-member 210 comprises one or more opaque regions 230 (which may be joined together) and one or more translucent or transparent regions 232 (which may also be joined together). The translucent or transparent regions 232 may be known as light-pipes, since they guide light through the light-shaping member 210. Light from the LEDs 214 can pass through the translucent or transparent regions 232 but is blocked by opaque regions 230. The opaque regions 230 therefore reduce the intensity of light passing through a subset of the apertures 204 (i.e. those arranged above the opaque regions 230). The opaque regions 230 and the translucent or transparent regions 232 may be regions of a single monolithic component, but one or both regions may have been treated to give the region its specific optical property. In another example, the opaque regions 230 and the translucent or transparent regions 232 are separate components which are overmolded.

In this example, the light-shaping member comprises an opaque region 238 extending around the periphery/perimeter/circumference of the light-shaping member 210. This can prevent light from leaking around the outside of the outer member 202. The opaque region may be an outer ring, for example.

In the present example the device 100 comprises four LEDs 214, and each of the LEDs 214 is positioned between adjacent opaque regions 230 such that the light from the LEDs separates into 4 quadrants. In other words, the LEDs 214 may be arranged below the transparent or translucent regions. By separating the light into the different regions, different indications can be provided to a user. For example, the number of illuminated quadrants can specify certain events to a user.

In some examples the regions between the opaque regions 230 are openings and therefore do not comprise translucent or transparent material.

Arranged between the light-shaping member 210 and the LEDs 214 is a sealing member 212, such as a gasket. The sealing member 212 has an outer diameter that is larger than the outer diameters of the outer member 202 and the light shaping member 210. In the example shown, the sealing member 210 comprises an annular recess 234 which can receive an annular protrusion formed on the inner surface of the light-shaping member 210. The annular recess 234 helps secure the light-shaping member 210. In some examples the annular protrusion is omitted. Additionally, or alternatively, the annular recess 234 can also collect liquid or dust which may enter through the opening 206 of the housing. In some examples, the light-shaping member 210 has a dome-shaped profile 236 to help guide liquid and dust into the annular recess 234.

In some examples the sealing member 210 abuts an inner surface of the housing 102 to stop liquid and dust from entering the device 100.

The above embodiments are to be understood as illustrative examples of the present disclosure. Further embodiments of the present disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the present disclosure.

1. An aerosol provision device comprising:
one or more Light Emitting Diodes (LEDs); and
an outer member positioned above the one or more LEDs, wherein the outer member defines a plurality of apertures visible from outside the aerosol provision device.

2. The aerosol provision device according to claim 1, wherein the plurality of apertures are slots.

3. The aerosol provision device according to claim 1, wherein the plurality of apertures have a length of less than about 2 mm.

4. The aerosol provision device according to claim 1, wherein the plurality of apertures have a width of less than about 0.5 mm.

5. The aerosol provision device according to claim 1, wherein the outer member has a thickness of less than about 2 mm.

6. The aerosol provision device according to claim 1, wherein the outer member is positioned above the one or more LEDs by a distance of between about 1.5 mm and about 5 mm.

7. The aerosol provision device according to claim 1, wherein the plurality of apertures are arranged towards a periphery of the outer member.

8. The aerosol provision device according to claim 7, wherein the plurality of apertures are equally spaced around a perimeter of the outer member.

9. The aerosol provision device according to claim 8, wherein the plurality of apertures comprises 36 apertures.

10. The aerosol provision device according to claim 1, further comprising:
an adhesive between the one or more LEDs and the outer member.

11. The aerosol provision device according to claim 10, further comprising:
a light-shaping member positioned between the one or more LEDs and the adhesive.

12. The aerosol provision device according to claim 11, wherein the light-shaping member comprises opaque regions configured to block a portion of the light from the one or more LEDs.

13. The aerosol provision device according to claim 12, comprising four LEDs, wherein each of the four LEDs is located below the light-shaping member and positioned between adjacent opaque regions such that light from the four LEDs separates into four quadrants.

14. The aerosol provision device according to claim 11, wherein the light-shaping member comprises polycarbonate.

15. The aerosol provision device according to claim 11, further comprising a scaling member arranged between the light-shaping member and the one or more LEDs.

16. An aerosol provision system, comprising:
the aerosol provision device according to claim 1; and
an article comprising aerosol generating material.
